(19) United States
(12) Patent Application Publication
(10) Pub. No.: US 2006/0176703 A1
(43) Pub. Date: Aug. 10, 2006

(54) Novelty lighting system

(76) Inventors: Paul E. Cayton, Stratford, CT (US); Jeffrey S. Love, Southport, CT (US)

Correspondence Address: McCARTER & English, LLP;Four Stamford Plaza, 107 Elm Street, Stamford, CT, 06902, US

(21) Appl. No.: 11/055,144

(22) Filed: Feb. 10, 2005

(51) Int. Cl. F21V 11/00

(52) U.S. Cl. 362/350; 362/227; 362/331; 362/240; 362/800; 362/802; 362/806; 362/809; 362/812; 362/329; 362/351

(57) ABSTRACT

Lighting units for use in a variety of enclosures/containers to achieve a desired illumination effect are provided. The enclosures/containers are susceptible to illumination from within, defining an interior region for receipt of a lighting unit. The enclosure/container and the lighting unit are combined to achieve a desired illumination effect, e.g., consistent with a holiday and/or seasonal theme. The lighting unit generally includes a plurality of light elements that are adapted to generate at least three light colors, e.g., red, green and blue. The light elements are adapted to generate light in a pre-selected manner, e.g., pursuant to a selected illumination pattern. The combination may be employed with enclosure(s) having holiday/seasonal themes, e.g., a Jack-O-Lantern, a pumpkin, a ghost, a witch, a black cat, a skeleton, a Santa Claus figure, a candy cane, a reindeer, a snow man, an igloo, a ski lodge, a snowmobile, and the like.

### BACKGROUND

1. Technical Field

The present disclosure is directed to a novelty lighting system and, more particularly, to a light unit that is configured and dimensioned to be utilized within or in conjunction with an enclosure or partial enclosure, e.g., a structure that is translucent or transparent, in whole or in part. Exemplary embodiments of the present disclosure include light units that are configured and dimensioned for use in conjunction with a pumpkin/Jack-O-Lantern or other luminary-type structure.

2. Background Art

There are numerous known applications that involve placement or positioning of a light source within a container/enclosure. In some such applications, the container/enclosure is transparent or translucent, thereby allowing the light source to project light into the surrounding environs. In other applications, the container/enclosure is adapted to permit light from the light source to be project through openings formed in the container/enclosure. The light source may be powered by one or more batteries and/or a power cord that communicates with a source of electricity, e.g., a wall outlet. The patent literature includes teachings relevant to lighting systems for enclosures, e.g., pumpkins, Jack-O-Lanterns and the like.

In U.S. Pat. No. 6,628,770 to Blatherwick, a decorative novelty illuminated sparkling pumpkin device is disclosed having a main body shell made of pelletized ethylene vinyl acetate copolymers bonded in a molding process, and a light source providing illumination within the hollow interior space of the main body shell. The pelletized ethylene vinyl acetate copolymers impart a sparkling/glowing effect upon illumination from the light source.

In U.S. Pat. No. 6,361,192 to Fussell et al., a light source enhancing lens assembly is provided that includes a carrier, a light source carried by the carrier, a first lens which refracts and diffuses light emitted from the light source and a second lens to defocus and further distribute the light emitting from the first lens. The light source is inserted into the first lens, so that light from the LED is refracted within a first bore and diffused by a frosted first outer surface of the first lens. The first lens inserts into a second bore of the second lens. Light from the first lens is further defocused by a series of parallel, spaced apart lens sections located on the second outer surface of the second lens. According to the Fussell '192 patent, the outer lens can take on an ornamental shape, allowing the lens assembly to be used in various novelty items, such as candles and jack-o-lanterns

In U.S. Pat. No. 6,224,234 to Demmery, a hollow carrier having a handle in the shape of a jack-o-lantern or the like is provided with a light and diffuser assembly. When the light is activated, a portion of the light is reflected onto a path external to the carrier while another portion of the light is reflected back into the carrier, illuminating the carrier's interior and allowing the person holding the carrier to be visible from all directions.

In U.S. Pat. No. 6,575,613 to Brown et al., an illumination device is provided that is especially adapted for internally illuminating a decorative object associated with a particular seasonal holiday, festive, or celebratory event. The illumination device includes a dome shaped housing that is sized and configured to mount inside the decorative object. The housing has concavities with reflective surfaces and electric lights that are disposed in the concavities. Electric current is supplied to the light for illumination of the interior of the decorative object. The illuminative object has the optional capability to flash the electric lights to mimic the flickering of a burning candle and employ the use of fiber optics for special lighting effects. A “Pumpkin Strobe Light” has been commercially offered by Pumpkin Masters, Inc. (Denver, Colo.) that embodies the subject matter of the Brown '613 patent. Design patent (D454,967 to Brown et al.) also relates to the foregoing illuminative object.

A further commercial product that allows pumpkin illumination has been commercially offered by Gemmy Industries Corp. (Coppell, Tex.) as a Pumpkin Light Kit (Product Code D12-338539). The Pumpkin Light Kit includes a substantially circular plastic base of two-part construction. An outer flange defines an upstanding circumferential lip that surrounds a central circular open region. Three inwardly directed mounting arms extend from the circumferential lip. A circular plate member is sized to fit within the central region and includes: (i) a pair of central upstanding support walls that define a cavity for receipt of a light socket, (ii) three arcuately spaced, downwardly extending, hollow legs that are sized to receive attachment screws, (iii) a pair of a cord clips molded onto the top of the circular plate member leading from the light socket cavity, and (iv) a pass-through channel adjacent the outermost wire clip to facilitate passage of a cord therethrough. The Pumpkin Light Kit is assembled by (i) positioning a light socket in the light socket cavity and threading the associated cord under the cord clips and through the pass-through channel, (ii) securing the circular plate relative to the outer flange by threading attachment screws through the hollow legs into the mounting arms. Thereafter, a light bulb (two light bulbs are provided with commercial product) is positioned in the socket, the Pumpkin Light is positioned in a pumpkin/Jack-O-Lantern and the power cord is passed from the pumpkin/Jack-O-Lantern to an electrical outlet.

Despite efforts to date, a need remains for light units that are configured and dimensioned for positioning/placement within a container/enclosure that

### SUMMARY OF THE DISCLOSURE

The present disclosure provides advantageous lighting units for use in a variety of enclosures/containers to achieve a desired illumination effect. The enclosures/containers of the present disclosure are typically plastic and susceptible to illumination from within. Thus, the enclosures/containers of the present disclosure typically define an interior region for receipt of a lighting unit. According to exemplary embodiments of the present disclosure, the enclosure/container and the lighting unit are combined to achieve a desired illumination effect, e.g., pursuant to a holiday and/or seasonal theme. According to an exemplary embodiment of the present disclosure, a combination is provided that includes an interior region and a lighting unit positioned within the interior region. The lighting unit generally includes a plurality of light elements that are adapted to generate at least three light colors, e.g., red, green and blue. The light elements are generally adapted to generate light in a pre-selected manner, e.g., pursuant to a selected illumination pattern. The disclosed combination may be advantageously employed with enclosure(s) having holiday/seasonal themes, e.g., a Jack-O-Lantern, a pumpkin, a ghost, a witch, a black cat, a skeleton, a Santa Claus figure, a candy cane, a reindeer, a snow man, an igloo, a ski lodge, a snowmobile, etc. Exemplary lighting units according to the present disclosure include a base member and a cover. The base member generally supports a reflector element and the light elements typically extend through apertures formed in the reflector element. The cover generally includes a window that is supported by an outer flange. The window defines an outer surface and an inner surface, and according to exemplary embodiments of the present disclosure a plurality of nubs/protuberances are formed on the inner surface of the window. The nubs define a grid, e.g., a substantially octagonal grid, on the surface of the window. Generally, the nubs are of at least two different sizes, i.e., larger nubs and smaller nubs. The larger and smaller nubs may be positioned in alternating rows on the window.

According to further exemplary combinations of the present disclosure, the lighting unit includes programmed circuitry that controls illumination of the light elements. The programmed circuitry may be formed or associated with a printed circuit board that is typically mounted with respect to the base member. The programmed circuitry generally supports a plurality of illumination parameters for the light elements and a selection mechanism typically permits a user to select from among the illumination parameters to achieve a desired effect. For example, the plurality of illumination parameters may include one or more sequential illumination patterns. Additionally, the illumination parameters may include illumination of a desired color based on the lighting elements associated with the lighting unit.

The disclosed lighting units, enclosures and combinations have a variety of applications and implementations, as will be readily apparent from the disclosure provided herein. Additional advantageous features and functionalities associated with the present disclosure will be apparent from the detailed description which follows, particularly when read in conjunction with the figures appended hereto.

### BRIEF DESCRIPTION OF THE FIGURES

To assist those of ordinary skill in the art in making and using the disclosed lighting units, reference is made to the appended figures, wherein:

FIG. 1 is an exploded view of an exemplary lighting unit according to the present disclosure;

FIG. 2 is a perspective view of a base component of an exemplary lighting unit according to the present disclosure;

FIG. 3 is a top view of the exemplary base component of FIG. 2;

FIG. 4 is a top view of the exemplary base component of FIGS. 2 and 3, with reflector reviewed;

FIG. 5 is a perspective view of a the underside of an exemplary cover according to the present disclosure; and

FIG. 6 is a schematic view, partially cut-away, of a lighting unit of the present disclosure positioned within a container/enclosure (Jack-O-Lantern).

### DESCRIPTION OF EXEMPLARY EMBODIMENTS

The lighting units of the present disclosure may be used in a variety of enclosures/containers to achieve a desired illumination effect. Thus, for example, the disclosed lighting units may be advantageously incorporated into hollow items that are shaped/molded into a configuration having significance for a season and/or holiday. For example, for Halloween-related applications, the disclosed lighting unit may be positioned within a hollow shell/figurine that takes the shape of a Jack-O-Lantern or pumpkin, a ghost, a witch, a black cat, a skeleton, or the like. For Christmas-related applications, the disclosed lighting unit may be positioned within a hollow shell/figurine that takes the form of Santa Claus, a candle, a candy cane, a reindeer, or the like. For the winter season, the disclosed lighting unit may be positioned within a hollow shell/figurine that takes the form of a snow man, an igloo, a ski lodge, a snowmobile or the like. A multitude of alternative implementations and applications of the disclosed lighting units are contemplated, as will be readily apparent to persons skilled in the art, and such alternative implementations/applications are expressly encompassed within the scope of the present disclosure.

The containers/enclosures of the present disclosure are typically plastic, and may be blow molded and/or injection molded. To impart a desired visual effect/appearance, the container/enclosure may be fabricated from dye-containing plastic materials and/or may be painted/colored subsequent to the molding/fabrication process. Alternatively, the container may be fabricated (in whole or in part) from other materials, e.g., glass, fiberglass or the like. The containers/enclosures may be made to hang from above or to be supported on the ground, or may be adapted to be displayed both in a hanging and a supported fashion.

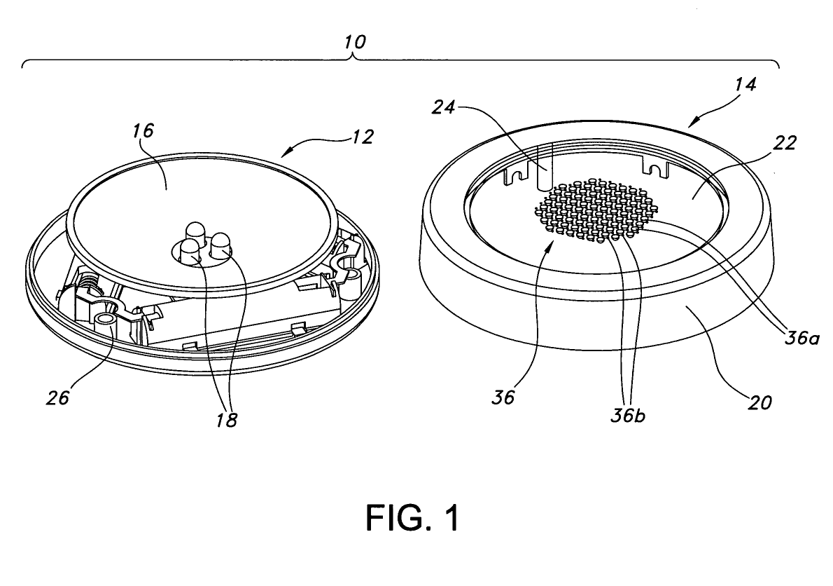

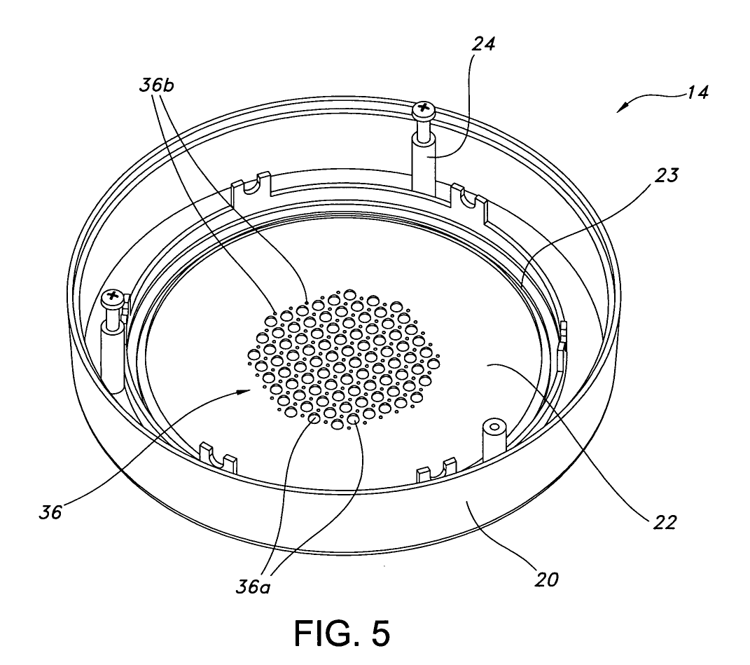

An exemplary embodiment of an advantageous lighting unit according to the present disclosure is depicted in the accompanying figures. With reference to FIG. 1, lighting unit 10 includes a base member 12 and a cover 14. The base member 12 supports a reflector element 16 that includes a plurality of apertures through which light elements 18 protrude. Cover 14 includes an outer flange 20 and a substantially planar window 22 that is supported by flange 20. A plurality of mounting legs 24 extend from the underside of flange 20 and are adapted to align with mounting channels 26 formed in base member 12. Screws (see FIG. 5) or other attachment members are typically used to detachably join the base member 12 and cover 14.

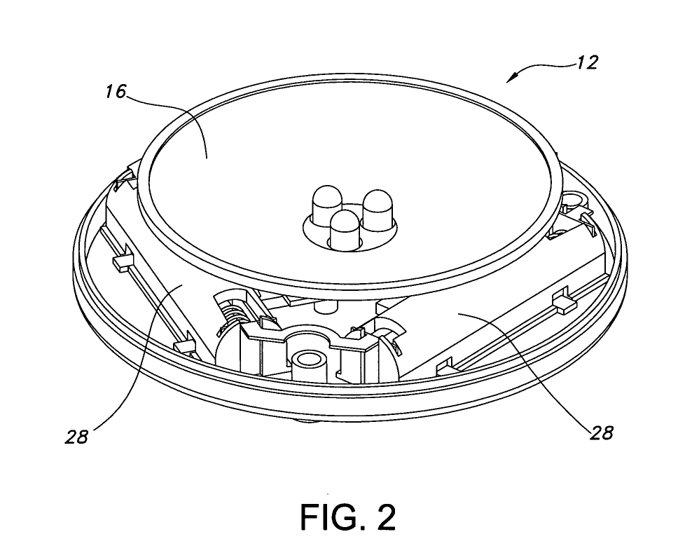

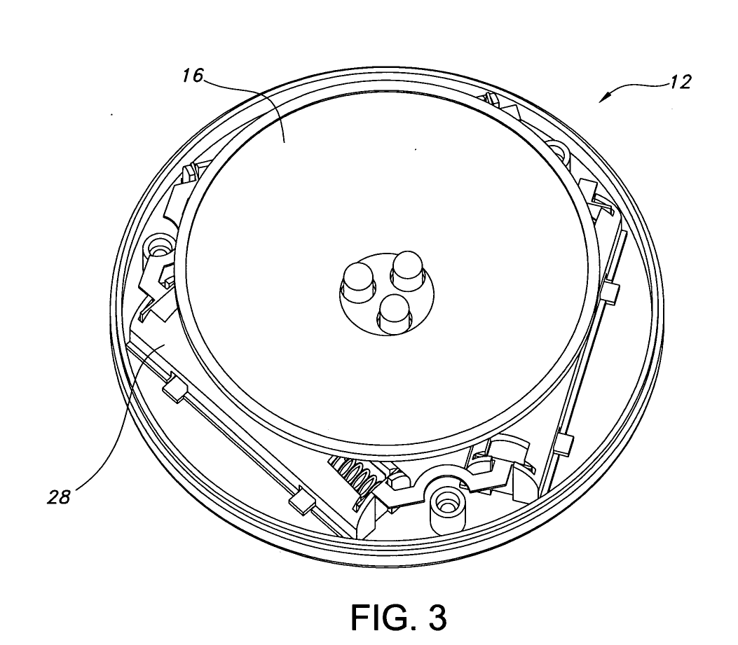

With reference to FIGS. 2 and 3, reflector element 16 is typically concave in geometry, such that incident light rays generated by light elements 18 are reflected through window 22. A reflective surface is formed or adhered to the upper surface of reflector element 16, as is known in the art. A central planar region (e.g., of circular geometry) may be formed at the center of reflector element 16 to facilitate mounting of the reflector with respect to the underlying structure of base member 12, i.e., to establish planar-to-planar contact. The diameter of reflector element 16 typically approximates the diameter of window 22, although a precise matching of diameters is not required according to the present disclosure. According to preferred embodiments of the present disclosure, the outer rim of reflector element 16 abuts (or is in close proximity to) the under surface of cover 14, thereby ensuring that light rays generated by light elements 18 exit through window 22.

According to the presently disclosed exemplary embodiment, three light elements 18 are centrally positioned in lighting unit 10. The light elements 18 are advantageously adapted to generate light of different colors. Thus, for example, light elements 18 may embody LEDs or filament-type light generation elements. According to an exemplary embodiment of the present disclosure, each light element 18 includes a cylindrical outer plastic body that transitions into a hemispheric upper region. The light generating element of each light element 18 is generally positioned within the cylindrical body portion of the light element.

With reference to FIGS. 2-4, a plurality of battery-receiving compartments 28 are defined in base member 12. The size/voltage of the batteries to be used with lighting unit 10 may vary depending on the desired light output and like factors. According to an exemplary embodiment of the present disclosure, three (3) AAA batteries are accommodated by three spaced battery compartments 28. Of course, alternative arrangements of battery compartments may be employed without departing from the spirit or scope of the present disclosure. Generally, the batteries are joined in series by connectors 30, such that power/current is delivered from the batteries to printed circuit board (PCB) 32 by wires 34a, 34b. Recharging functionality may be provided with lighting units of the present disclosure. Thus, for example, an AC adapter connection may be associated with the electronic circuitry described herein to facilitate the delivery of recharging current to the disclosed system.

According to an exemplary embodiment of the present disclosure, the base member is designed to receive three AAA batteries to power operation of the lighting system. The batteries are removable from the base member and operation of the lighting system is activated through addition/removal of the batteries, i.e., wireless activation. In a further exemplary embodiment of the present disclosure, activation of the disclosed lighting unit is controlled by plugging an AC port into an electrical outlet/wall socket.

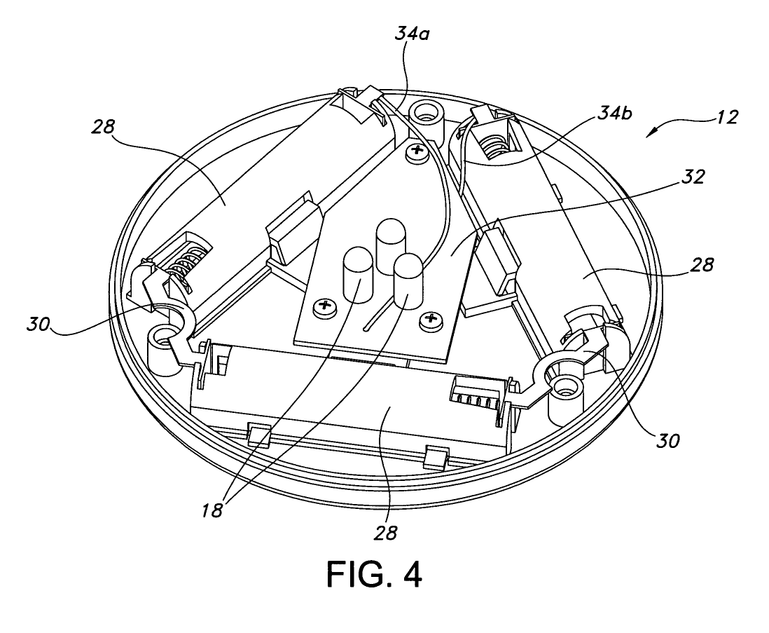

With particular reference to FIG. 4, PCB 32 is mounted with respect to base member 12, e.g., by a pair of screws. Light elements 18 are positioned on (or are mounted with respect to) PCB 32. A switch is typically associated with PCB 32 to facilitate activation/deactivation of lighting unit 10. For example, a toggle-type switch may be provided that is accessible from the underside of base member 12, although alternative switching structures and/or techniques may be employed without departing from the spirit or scope of the present disclosure. For example, switching functionality may be associated with sensor technology, e.g., a motion and/or vibration sensor, that activates lighting unit 10 in response to appropriate stimuli.

Once activated, power is supplied to light elements 18 through the circuitry and control functions associated with PCB 32. One or more integrated circuits may be mounted with respect to PCB 32 to supply lighting control features/functionalities to the disclosed lighting unit 10. Thus, according to exemplary embodiments of the present disclosure, PCB 32 is provided with light sequencing functionality that supports at least the following advantageous lighting operations:
(1) sequential operation of the plurality of light elements, such that one light element is illuminated at a time—the sequential operation may impart a “flashing” effect to the disclosed lighting unit;
(2) sequential operation of the plurality of light elements, such that a second light element is powered up, i.e., becomes illuminated, while the previously illuminated light element is powered down, i.e., loses light intensity—the sequential operation may impart a “flashing” effect to the disclosed lighting unit;
(3) selective operation by the system user, such that a selection is made as to which light element and/or light elements to illuminate. Thus, in the disclosed exemplary embodiment wherein three (3) light elements are incorporated into lighting unit 10, the system user would have seven (7) illumination choices—light element 1 alone, light element 2 alone, light element 3 alone, light elements 1 and 2 together, light elements 2 and 3 together, light elements 1 and 3 together, and light elements 1, 2 and 3 together. Selection may be achieved in a variety of ways (through interaction with the control circuitry of PCB 32), e.g., by pressing a selection button/member once for option #1, twice for option #2, and so on, or by the duration of a user's interaction with a selection button/member, with the shortest duration corresponding to option #1, a slightly longer duration corresponding to option #2, etc. In either case, a user would advantageously have the opportunity to view the light color generated by the available choices, and may settle on the choice best suited to his/her application/implementation.

The programming of the noted lighting functionalities is well within the skill of individuals having ordinary skill in the art. However, the implementation of lighting functionalities and associated user control interactivity in the context of the disclosed lighting units is highly advantageous and provides significant benefits and flexibility to users of the disclosed lighting units and lighting unit assemblies.

In a further exemplary embodiment of the present disclosure, control of the multi-function LED lighting mechanism described herein is effected by a button located on the back of the lighting unit. Thus, for example, a user can choose from among eight (8) different lighting selections by pressing the button on the back of the unit. In an exemplary implementation of the present disclosure, by repeatedly pressing the control button, a user can choose from among seven (7) solid, non-flashing colors or an eighth choice wherein the light changes color automatically and continually, e.g., until the unit is turned off.

Turning to FIG. 5 and with further reference to FIG. 1, window 22 is typically substantially circular in geometry and is mounted with respect to outer flange 20, e.g., by an adhesive, sonic welding or a structural mounting mechanism, e.g., a snap-fit or bayonet lock arrangement. According to exemplary embodiments of the present disclosure, window 22 is provided with a peripheral mounting rim 23 that facilitates mounting interaction with outer flange 20. A plurality of light diffraction nubs or protuberances 36 are formed on window 22. Nubs 36 are typically oriented inwardly, i.e., toward light elements 18, and are deployed so as to effect diffraction/refraction of light rays emitted from light elements 18. According to the disclosed exemplary embodiment, nubs 36 are of two sizes, a first set of larger nubs 36a and a second set of smaller nubs 36b. Both the larger and smaller nubs 36a, 36b are deployed in equally spaced rows, with the smaller nub rows positioned between the larger number rows (and vice versa).

In the disclosed exemplary embodiment of FIGS. 1 and 5, nubs 36 define an octagonal light diffraction/refraction grid, with a five smaller nubs 36b defining the outer-most row on each of the four longest sides of the octagonal shape. Rows of six larger nubs 36a are positioned adjacent these outer-most smaller nub rows, followed by a row of seven smaller nubs 36b, etc. In its “widest region, the disclosed grid includes rows of smaller nubs 36b made up of eleven individual nubs 36b. In an exemplary embodiment of the present disclosure, the widest region measures approximately 1.25 inches.

Of note, the grid region is centrally positioned on window 22 and is therefore positioned above light elements 18. Indeed, the nub grid typically extends outwardly beyond the positioning of light elements 18, e.g., by a distance of about 0.5 inches. Thus, light rays that are directed upwardly from light elements 18 generally pass through the grid region of window 22. However, not all light rays are diffracted/refracted because planar window regions allow substantially direct light transmission between adjacent nubs. Nonetheless, the combination of the light elements 18 and the grid region defined on window 22 provides an advantageous lighting effect according to the present disclosure. The advantageous lighting effect is further enhanced through the alternative lighting operations described above, e.g., the sequential operation of the individual lighting elements that emit light of different colors.

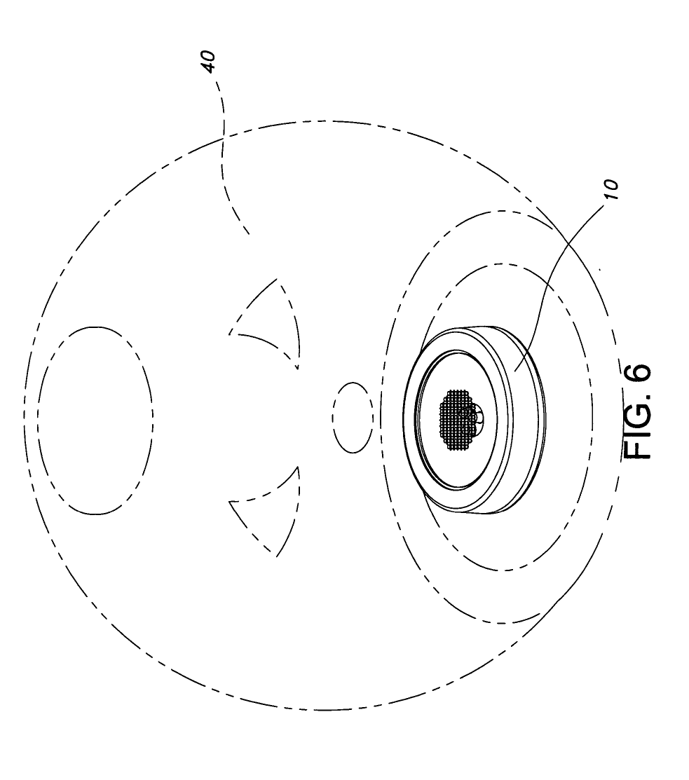

Turning to FIG. 6, exemplary lighting unit 10 is shown positioned within a container/enclosure 40. Typically, the lighting unit 10 is activated before positioning within enclosure 40. However, in instances where light activation is effected through sensor functionality, e.g., a movement sensor, the light elements may not be illuminated when initially positioned within the enclosure. As shown in FIG. 6, light emitted by lighting unit 10 will illuminate the interior of enclosure 40, providing an internal glow thereto, and will pass outward through the openings formed in enclosure 40, e.g., the eye and nose openings). Although exemplary enclosure 40 takes the form of a Jack-O-Lantern, the present disclosure is not limited to such applications, as noted above. Rather, the lighting unit of the present disclosure may be combined with a variety of containers/enclosures, e.g., figurines, to achieve desired illumination effects.

In short, the disclosed lighting unit when used in combination with a container/enclosure provides novel and advantageous lighting effects. In exemplary embodiments wherein lighting elements of different color are provided, a “rainbow” lighting effect may be achieved. Further lighting operations (sequential, selective, etc.) may be provided and may be subject to user choice, as described herein. The disclosed combination may take many forms and achieve many desired effects, e.g., for various seasons, holidays and the like. Thus, although the present disclosure has been described with reference to exemplary embodiment(s) thereof, the disclosure is not limited to such exemplary embodiment(s). Indeed, the present disclosure extends to and encompasses modifications, enhancements and/or variations hereof, consistent with the spirit and scope of the disclosure provided herein.

1. In combination:
a. an enclosure defining an interior region;
b. a lighting unit positioned within said interior region of said enclosure, said lighting unit including a plurality of light elements that generate at least three light colors, said light elements being adapted to generate light in a pre-selected manner.

2. A combination according to claim 1, wherein said enclosure is a hollow-shelled item.

3. A combination according to claim 1, wherein said enclosure is a figurine.

4. A combination according to claim 1, wherein said enclosure is fabricated in a form having a holiday or seasonal theme.

5. A combination according to claim 4, wherein said enclosure is selected from the group consisting of a Jack-O-Lantern, a pumpkin, a ghost, a witch, a black cat, a skeleton, a Santa Claus figure, a candy cane, a reindeer, a snow man, an igloo, a ski lodge, and a snowmobile.

6. A combination according to claim 1, wherein said lighting unit includes a base member and a cover.

7. A combination according to claim 6, wherein said base member supports a reflector element and wherein said plurality of light elements extend through said reflector element.

8. A combination according to claim 6, wherein said cover includes a window.

9. A combination according to claim 8, wherein said window is supported by an outer flange.

10. A combination according to claim 8, wherein said window defines an outer surface and an inner surface, and wherein a plurality of nubs are formed on said inner surface of said window.

11. A combination according to claim 10, wherein said plurality of nubs define a substantially octagonal grid.

12. A combination according to claim 10, wherein said plurality of nubs include nubs of at least two different sizes.

13. A combination according to claim 12, wherein said at least two different sizes are first nubs and second nubs, and wherein said first nubs are larger than said second nubs.

14. A combination according to claim 13, wherein said first nubs and said second nubs are positioned in alternating rows.

15. A combination according to claim 1, wherein said lighting unit includes programmed circuitry that controls illumination of said plurality of light elements.

16. A combination according to claim 15, wherein said programmed circuitry includes a printed circuit board.

17. A combination according to claim 15, wherein said programmed circuitry supports a plurality of illumination parameters for said plurality of light elements.

18. A combination according to claim 17, wherein said programmed circuitry cooperates with a selection mechanism that permits a user to select from said plurality of illumination parameters for said plurality of light elements.

19. A combination according to claim 17, wherein said plurality of illumination parameters includes sequential illumination of said plurality of light elements.

20. A combination according to claim 17, wherein said plurality of illumination parameters includes selection of a desired illumination from said at least three light colors.

21. A combination according to claim 17, wherein said plurality of illumination parameters includes at least two sequential illumination operations, wherein a first of said two sequential illumination operations provides for powering up of a second light element while a first light element is powering down, and wherein a second of said two sequential illumination operations provides for illuminating only one light element at a time.
